(19) United States
(12) Patent Application Publication
(10) Pub. No.: US 2015/0310187 A1
(43) Pub. Date: Oct. 29, 2015

(54) METHODS AND DEVICES FOR IDENTIFYING IMPROPER MEDICAL REPORTING

(71) Applicant: JONATHAN RABINOWITZ, RAANANA (IL)

(72) Inventor: JONATHAN RABINOWITZ, RAANANA (IL)

(21) Appl. No.: 14/791,507

(22) Filed: Jul. 6, 2015

Related U.S. Application Data
(63) Continuation-in-part of application No. PCT/IB2014/058073, filed on Jan. 6, 2014.
(60) Provisional application No. 61/749,324, filed on Jan. 6, 2013.

(51) Int. Cl. G06F 19/00

(52) U.S. Cl. CPC G06F 19/36

(57) ABSTRACT

Some embodiments of the invention relate to pharmaceuticals, clinical trials and reporting, and more specifically to finding duplicate medical reporting in clinical trials or when reporting adverse events attributed to drug use. Some embodiments of the invention relate to clinical trials, and more particularly to methods and devices for improving the results of clinical trials by preventing improper participation in clinical trials.

### CROSS-REFERENCE TO RELATED APPLICATIONS

This application is a continuation-in-part of International Application Number PCT/IB2014/058073 filed Jan. 6, 2014, which claims the benefit of priority from U.S. Provisional Patent Application No. 61/749,324, filed Jan. 6, 2013, the disclosures of which are incorporated herein by reference in their entirety.

### BACKGROUND

Most drug trial protocols state that when conducting a clinical trial, people who are concurrently enrolled in the same clinical trial or in another clinical trial, or who have recently participated in another clinical trial, are not eligible to participate in the current clinical trial. This is due to the fact that duplicate participation in a clinical trial can severely bias the results of the clinical trial, to the degree that even a small number of duplicate participants can lead to a negative or failed trial. Additionally, participation in two concurrent clinical trials, or participation in a second clinical trial shortly after completion of a first clinical trial, may affect the participant's reaction to the drugs provided in the second clinical trial, may lead to undesirable drug interaction, and in severe cases even to death.

Current systems for entering participants into clinical trials, do not allow the medical personnel conducting the trial to objectively determine whether or not a potential participant is concurrently enrolled in another trial or is currently enrolled in the same trial. The medical personnel must trust the honesty of the potential participant, who may be disinclined to report concurrent participation in another clinical trial or in the same clinical trial due to the knowledge that they will be excluded from the current clinical trial and may lose financial benefits, or medicinal benefits, resulting from such participation.

Additionally, using current systems, once a clinical trial is complete there is no way to retroactively determine whether or not the results are biased due to duplicate participation of one or more patients in the trial.

There is thus a need for a system and method for identifying duplicate or other unsuitable participation in clinical trials at the time of registration to, or screening of potential participants in, a clinical trial. There is further a need for a system and method for identifying whether there was duplicate participation in a completed clinical trial, and for cleaning the results of the clinical trial if such duplicate participation was identified.

In many cases, a single patient is treated by multiple medical professionals who operate independently of one another, such as, for example, by a family doctor and a gynecologist. Each medical professional may prescribe different drugs, which are used to concurrently treat the patient. When an adverse event, or side effect, occurs, the patient typically reports the occurrence of the event to all treating medical professionals, which may then attribute the adverse event to the drug they prescribed, not knowing about the other drugs taken by the patient. As a result, each of the medical professionals may report the adverse event to the drug company manufacturing the drug they prescribed, or to a central authority in charge of collecting reports of adverse events, such as the FDA. Such duplicate reporting may result in an inaccurate understanding of the possible adverse events caused by each of the drugs, due to improper association of an adverse event with drugs that did not cause the event.

There is thus a need for a system and method for identifying whether there was duplicate reporting of a single adverse event, and for cleaning data relating to such adverse events if duplicate reporting was identified.

### SUMMARY

Some embodiments of the invention relate to methods and devices for improving the results of clinical trials by preventing improper participation in clinical trials.

The invention, in some embodiments, relates to the field of clinical trials and reporting, and more specifically to finding duplicate medical reporting in clinical trials or when reporting adverse events attributed to drug use.

The invention, in some embodiments, relates to the field of clinical trials, and more particularly to methods and devices for improving the results of clinical trials by preventing improper participation in clinical trials when screening new potential participants for the trial.

The invention, in some embodiments, relates to the field of adverse medical events, and more particularly to methods and devices for improving the understanding of possible adverse effects caused by drugs by preventing duplicate reporting of a single adverse event.

According to an aspect of some embodiments of the invention there is provided a method for identifying improper, or duplicate, participation in a clinical trial, including receiving identifying data for an individual, comparing the received identifying data of the individual to identifying data of clinical trial participants included in a clinical trial participant database, and if the identifying data of the individual matches identifying data of a specific clinical trial participant in the database, providing exclusion data identifying said individual for exclusion from said clinical trial.

In some embodiments, the identifying data is received when screening the individual for participation in the clinical trial.

The individual may be any suitable individual. In some embodiments, the individual includes a participant in the clinical trial. In some embodiments, the individual includes a potential participant, not yet entered to participate in the clinical trial.

In the context of the following disclosure, a potential participant is a person who may be included in a clinical trial based on commonly used exclusion and inclusion criteria. For example, a person would not be considered a potential participant if any one or more of the following apply: the person is not in a suitable age range, the person has severe and/or non-related preexisting medical conditions, the person is a female who is pregnant and/or breastfeeding or is not practicing contraception, the person is a substance abuser, and the person is unable to understand or to provide informed consent.

In some embodiments, providing exclusion data includes providing the exclusion data if at least one match exclusion criterion is met.

In some embodiments, the method also includes encrypting the received identifying data. In some such embodiments, the identifying data included in the clinical trial participant database includes encrypted identifying data of clinical trial participants, and the comparing includes comparing the encrypted identifying data of the individual to encrypted identifying data in the database. The identifying data may be any suitable identifying data which would assist in uniquely identifying the individual. For example, the identifying data may include any or all of first name, last name, initials, number of letters in the first and/or last names, date of birth, place of birth, sex, weight, height, eye color, race, ethnicity, blood type, waist size, hip size, address, national identification number such as a social security number or a passport number, and one or more biometric identifiers of the individual, such as one or more of fingerprints, iris prints, hand prints, images suitable for facial recognition, voice print, DNA snips, DNA signature, and the like.

The match exclusion criterion may be any suitable exclusion criterion relating to matching identifying data entries. That said, in some embodiments, the match exclusion criterion includes excluding any individual who is already participating in the clinical trial. In some embodiments, the match exclusion criterion includes excluding any individual who is already participating in another clinical trial. In some embodiments, the match exclusion criterion includes excluding any individual who has participated in another clinical trial within a predetermined period of the clinical trial, such as, for example, excluding any individual who has participated in another clinical trial within a month, six months, or a year of the clinical trial.

In some embodiments, the method also includes receiving the match exclusion criterion prior to the providing exclusion data step. In some such embodiments, the match exclusion criterion is entered by a user into a client computing device, such as by a medical professional seeking to enroll suitable individuals in the clinical trial.

In some embodiments, the identifying data of the individual is entered by a user into a client computing device, such as on a device used by a medical professional seeking to enroll suitable individuals in the clinical trial.

The client computing device may be any suitable computing device, such as a desktop computer, a laptop computer, a tablet computer, a mobile telephone such as a smart-phone, a Personal Digital Assistant (PDA), a suitably configured wired or wireless telephone, or any other suitable type of computing device. The client computing device may be functionally associated with an Interactive Voice Response System (IVRS) suitable for entry of the identifying data and/or other information of the individual.

In some embodiments, the comparing is carried out at a server functionally associated with the clinical trial participant database, and the method also includes transmitting the identifying data of the individual to the server. In some embodiments, the database includes, or is functionally associated with, an Interactive Voice Response System (IVRS).

In some embodiments, the identifying data of the individual is transmitted to the server, and the encrypting is carried out at the server.

In some embodiments, the encrypting is carried out on the client computing device, and the transmitting includes transmitting the encrypted identifying data of the individual to the server.

In some such embodiments, the method also includes manipulating the identifying data of the individual.

In some such embodiments, the manipulating includes creating multiple identifying data listings by changing one or more values corresponding to one or more data elements in the identifying data of the individual. Typically, the data elements include data element for which measurement variance or actual variance is likely or common, such as height, weight, and hip and waist circumference measurement. In some embodiment, the creating includes, in each identifying data listing, changing a value corresponding to a single identifying data element in the identifying data of the individual. In some embodiments, the value includes a height value. In some embodiments, the value includes a weight value. In some embodiments, the value includes a waist circumference measure. In some embodiments, the value includes a hip circumference measurement.

In some embodiments, the creating multiple identifying data listings is carried out while the identifying data of the individual is encrypted.

In some embodiments, the creating multiple identifying data listings is carried out when the identifying data of the individual is not encrypted.

In some such embodiments, the creating multiple identifying data listings is carried out at the client computing device immediately following entry of the identifying data of the individual, prior to encryption of the identifying data of the individual. The identifying data of the individual and identifying data listings may then be encrypted at the client computing device and/or at the server.

In some such embodiments, for example when encryption is carried out at the server, the creating multiple identifying data listings is carried out at the server, prior to the encrypting. In some such embodiments, the encrypting of the identifying data of the individual includes encrypting the identifying data as well as each of the identifying data listings.

In some such embodiments, for example when encryption is carried out at the client computing device, the method further includes decrypting the encrypted identifying data of the individual at the server, and creating multiple identifying data listings is subsequent to the decrypting. In some such embodiments, the re-encrypting includes re-encrypting the identifying data of the individual and encrypting each of the identifying data listings.

In some embodiments, the comparing includes comparing each of the identifying data listings to identifying data of clinical trial participants in the database. In some such embodiments, providing exclusion data includes providing exclusion data identifying said individual for exclusion from said clinical trial if at least one of said identifying data listings matches identifying data of a specific clinical trial participant in said database and/or if the at least one exclusion criterion is met.

In some embodiments, the method also includes enrolling the individual in the clinical trial, if no exclusion data identifying the individual for exclusion from the clinical trial was provided. For example, this may occur if the identifying data of the individual did not match identifying data of any clinical trial participant in the database and/or if the at least one match exclusion criterion was not met.

In some such embodiments, the enrolling includes enrolling the individual in the clinical trial if none of the identifying data listings matched identifying data of any clinical trial participant in the database and/or if the at least one match exclusion criterion was not met.

In some embodiments, the match exclusion criterion includes multiple exclusion criteria. In some such embodiments, the enrolling includes enrolling the individual in the clinical trial if one or more of the match exclusion criteria are not met. In some such embodiments, the enrolling includes enrolling the individual in the clinical trial if none of the match exclusion criteria are met.

In some embodiments, the method also includes reporting information regarding the individual. In some such embodiments, the information is provided to the user, such as to a medical professional seeking to enroll the individual in the clinical trial. In some embodiments, the reporting includes visually reporting the information, such as by presenting the information on a display. In some embodiments, the display is functionally associated with the client computing device. In some such embodiments, the display forms an integral part of the client computing device.

In some embodiments, the reporting includes reporting that exclusion data identifying the individual for exclusion from the clinical trial was provided. In some embodiments, the reporting includes reporting that the individual was excluded from the clinical trial. In some such embodiments, the reporting also includes reporting a reason for exclusion of the individual and/or reporting at least one match exclusion criterion that was met. For example, the report may state that the individual is already enrolled in the clinical trial, is concurrently enrolled in another clinical trial, or participated in another clinical trial which was completed within the predetermined time frame. In some embodiments, the report may also include the date of enrollment in the clinical trial or in another clinical trial, the date of termination of a clinical trial in which the individual had participated, and/or the name and indication of another clinical trial in which the individual had participated.

In some embodiments, the reporting includes reporting that the individual may be enrolled in the clinical trial. In some embodiments, the reporting includes reporting that the individual had been successfully enrolled in the clinical trial.

In some embodiments, the method is carried out as a background process, for example while other data capture process run in the foreground. In some such embodiments, exclusion data, if found, is provided via an out-of-line reporting method, such as a pop-up window, an email message, a telephone message, and the like.

According to an aspect of some embodiments of the invention there is provided a device for identifying improper participation in a specific clinical trial, including a clinical trial participant database including identifying data of participants in at least one clinical trial, a data entry module configured to receive identifying data of an individual, a comparison module configured to compare the identifying data of the individual to identifying data of clinical trial participants in the clinical trial participant database, and an analysis module, functionally associated with the comparison module, and configured to receive comparison results of the comparison module and to provide exclusion data identifying said individual for exclusion from said specific clinical trial if said identifying data of said individual matches identifying data of a specific clinical trial participant in said database.

The individual may be any suitable individual. In some embodiments, the individual includes a participant in the clinical trial. In some embodiments, the individual includes a potential participant, not yet entered to participate in the clinical trial.

In the context of the following disclosure, a potential participant is person who may be included in a clinical trial based on the commonly used exclusion and inclusion criteria. For example, a person would not be considered a potential participant, if any one or more of the following apply: the person is not in a suitable age range, the person has severe and/or non-related preexisting medical conditions, the person is a female who is pregnant and/or breastfeeding or is not practicing contraception, the person is a substance abuser, and the person is unable to understand or to provide informed consent.

In some embodiments, the analysis module is configured to provide the exclusion data if at least one match exclusion criterion is met.

In some embodiments, the data entry module is configured to receive the identifying data during screening of the individual for participation in the clinical trial.

In some embodiments, the device also includes an encryption module configured to receive the identifying data for the individual and to encrypt the received identifying data of the individual. In some such embodiments, the clinical trial participant database including identifying data of participants in at least one clinical trial, and the comparison module is configured to compare encrypted identifying data of the individual to encrypted identifying data in the database. The identifying data may be any suitable identifying data which would assist in uniquely identifying the individual. For example, the identifying data may include any or all of first name, last name, initials, number of letters in the first and/or last names, date of birth, place of birth, sex, weight, height, eye color, race, ethnicity, blood type, waist size, hip size, address, national identification number such as a social security number or a passport number, and one or more biometric identifiers of the individual, such as one or more of fingerprints, iris prints, hand prints, images suitable for facial recognition, voice print, DNA snips, DNA signature, and the like.

The match exclusion criterion may be any suitable exclusion criterion relating to matching identifying data entries. That said, in some embodiments, the match exclusion criterion includes excluding any individual who is already participating in the clinical trial. In some embodiments, the match exclusion criterion includes excluding any individual who is already participating in another clinical trial. In some embodiments, the match exclusion criterion includes excluding any individual who has participated in another clinical trial within a predetermined period of the clinical trial, such as, for example, excluding any individual who has participated in another clinical trial within a month, six months, or a year of the clinical trial.

In some embodiments, the data entry module is also configured receive thereinto the match exclusion criterion.

In some embodiments, the data entry module is functionally associated with an input device, the input device being configured to be used by a user for entering the identifying data of the individual and/or the match exclusion criterion. For example, the user may be a medical professional seeking to enroll suitable individuals in the clinical trial. The input device may be any suitable input device, such as a keyboard, a mouse, a microphone, a finger print or retina scanner, a camera, a DNA scanner, or any other suitable input device which may be used by the user to enter data into the data entry module.

The client computing device may be any suitable computing device, such as a desktop computer, a laptop computer, a tablet computer, a mobile telephone such as a smart-phone, a Personal Digital Assistant (PDA), a suitably configured wired or wireless telephone, or any other suitable type of computing device. The client computing device may be functionally associated with an Interactive Voice Response System (IVRS) suitable for entry of the identifying data and/or other information of the individual.

In some embodiments, the comparison module forms part of a server. In some such embodiments, the identifying data of the individual is transmitted from the client computing device to the server via at least one transceiver.

In some embodiments, the encryption module forms part of the server. In some embodiments, the encryption module forms part of the client computing device. In some such embodiments, the device also includes a second encryption module forming part of the server.

In some embodiments, the device also includes a data manipulation module, configured to manipulate the identifying data of the individual.

In some embodiments, the data manipulation module is configured to create multiple identifying data listings by changing one or more values corresponding to one or more data elements in the identifying data of the individual. Typically, the data elements include data elements for which measurement or actual variance is likely or common, such as height, weight, and waist and hip circumference measurements. In some embodiments, the data manipulation module is configured to change, in each identifying data listing, a value corresponding to a single identifying data element in the identifying data of the individual. In some embodiments, the value includes a height value. In some embodiments, the value includes a weight value. In some embodiments, the value includes a waist circumference measurement value. In some embodiments, the value includes a hip circumference measurement value.

In some embodiments, the data manipulation module is configured to create multiple identifying data listings while the identifying data of the individual is encrypted.

In some embodiments, the data manipulation module is configured to create multiple identifying data listings while the identifying data of the individual is not encrypted.

For example, in some embodiments, the identifying data of the individual is manipulated immediately following receipt thereof in the data entry module, prior to encryption of the data. In some such embodiments, the data manipulation module forms part of the data entry module. In some such embodiments, the encryption module is configured to encrypt the identifying data of the individual as well as each of the identifying data listings.

In some such embodiments, the data manipulation module forms part of the server. In some such embodiments, the device also includes a decryption module forming part of the server and functionally associated with the encryption module and with the data manipulation module, configured to receive the encrypted identifying data of the individual from the encryption module, to decrypt the identifying data of the individual, and to provide the decrypted identifying data of the individual to the data manipulation module. In some such embodiments, the device includes a second encryption module, forming part of the server and functionally associated with the data manipulation module, configured to re-encrypt the identifying data of the individual and to encrypt each of the identifying data listings.

In some embodiments, the comparison module is configured to compare each of the identifying data listings to identifying data of clinical trial participants in the database. In some such embodiments, the analysis module is configured to provide exclusion data identifying the individual for exclusion from said specific clinical trial if at least one of the identifying data listings matches identifying data of a specific clinical trial participant in the clinical trial participant database and/or if the at least one match exclusion criterion is met.

In some embodiments, the analysis module is also configured to enroll the individual in the clinical trial, if exclusion data identifying the individual for exclusion from the clinical trial was not provided, for example if the identifying data of the individual did not match identifying data of any clinical trial participant in the database and/or if the at least one match exclusion criterion was not met.

In some such embodiments, the analysis module is configured to enroll the individual in the clinical trial if none of the identifying data listings matched identifying data of any clinical trial participant in the database and/or if the at least one match exclusion criterion was not met.

In some embodiments, the match exclusion criterion includes multiple exclusion criteria. In some such embodiments, the analysis module is configured to enroll the individual in the clinical trial if one or more of the exclusion criteria are not met. In some such embodiments, the analysis module is configured to enroll the individual in the clinical trial if none of the exclusion criteria are met.

In some embodiments, the analysis module is also configured to report information regarding the individual. In some such embodiments, analysis module is functionally associated with a display, and is configured to present the information to the user on the display. In some embodiments, the display is functionally associated with the client computing device. In some such embodiments, the display forms an integral part of the client computing device.

In some embodiments, the analysis module is configured to report that exclusion data identifying the individual for exclusion from the specific clinical trial was provided. In some embodiments, the analysis module is configured to report that the individual was excluded from the clinical trial. In some such embodiments, the analysis module is also configured to report a reason for exclusion of the individual and/or the at least one match exclusion criterion that was met. For example, the report may state that the individual is already enrolled in the clinical trial, is concurrently enrolled in another clinical trial, or participated in another clinical trial which was completed within the predetermined time frame. In some embodiments, the report may also include the date of enrollment in the clinical trial or in another clinical trial, the date of termination of a clinical trial in which the individual had participated, and/or the name of another clinical trial in which the individual had participated.

In some embodiments, the analysis module is also configured to report that the individual may be enrolled in the clinical trial. In some embodiments, the analysis module is also configured to report that the individual had been successfully enrolled in the clinical trial.

In some embodiments, the analysis module is also configured to report ongoing screening and recruitment to the clinical trial by the sponsor of the clinical trial.

In some embodiments, at least one of the comparison module and the analysis module includes a software process, configured to run as a background process, for example while a data collection process runs in the foreground.

The invention, in some embodiments, relates to the field of medical information, and more particularly to methods and devices for identifying errors in collection of medical information for improving the accuracy of the medical information. In some embodiments, the medical information is the results of a clinical trial which are made more accurate by removal of duplicate participants. In some embodiments, the medical information includes information regarding adverse effects which may be caused by a drug or pharmaceutical, which is made more accurate by preventing duplicate reporting of a single adverse event.

According to an aspect of some embodiments of the invention there is provided a method for improving the accuracy of medical information, including, for each member in a group of people used to determine the medical information, obtaining identifying data of the member, comparing the obtained identifying data of the member at least to identifying data of each other member in the group of people, and if the obtained identifying data of the member matches identifying data of at least one other member in the group, removing the member and the at least one other member from the group of people, and if at least one member was removed from the group of people, notifying a user of the removal of the at least one member from the group of people.

In some embodiments, the notifying includes notifying the user of the identity of the at least one member removed from the group of people. In some embodiments, the method further includes reevaluating the medical information following the removal of the at least one member.

The identifying data may be any suitable identifying data which would assist in uniquely identifying the potential participant. For example, the identifying data may include any or all of first name, last name, initials, number of letters in the first and/or last names, date of birth, place of birth, sex, weight, height, eye color, race, ethnicity, blood type, waist size, hip size, address, national identification number such as a social security number or a passport number, and one or more biometric identifiers of the potential participant, such as one or more of fingerprints, iris prints, hand prints, images suitable for facial recognition, voice print, and the like.

In some embodiments, the obtaining includes obtaining encrypted identifying data. In some such embodiments, the comparing includes comparing encrypted identifying data.

In some embodiments, the comparing is carried out at a server, functionally associated with a database containing identifying data at least for each member on the group of people.

In some such embodiments, the method also includes manipulating the identifying data of the member.

In some such embodiments, the manipulating includes creating multiple identifying data listings by changing one or more values corresponding to one or more data elements in the identifying data. Typically, the data elements include data elements for which measurement or actual variance is likely or common, such as height, weight, and waist and hip circumference measurements. In some embodiment, the creating includes, in each identifying data listing, changing a value corresponding to a single identifying data element in the identifying data. In some embodiments, the value includes a height value. In some embodiments, the value includes a weight value. In some embodiments the value includes a waist circumference value. In some embodiments the value includes a hip circumference value.

In some embodiments, the creating multiple identifying data listings is carried out while the data is encrypted.

In some embodiments, the creating multiple identifying data listings is carried out when the data is not encrypted.

In some such embodiments, the manipulating also includes decrypting the encrypted identifying data of the member, and creating multiple identifying data listings is subsequent to decrypting. In some such embodiments, the manipulating also includes re-encrypting the identifying data and encrypting each of the identifying data listings.

In some embodiments, the comparing includes comparing each of the identifying data listings to the identifying data of at least each other member in the group.

In some embodiments, the obtaining identifying data of the member includes entering identifying data of each member in the group.

In some embodiments, the identifying data of the members in the group is entered by a user into a client computing device. The client computing device may be any suitable computing device, such as a desktop computer, a laptop computer, a tablet computer, a mobile telephone such as a smart-phone, a Personal Digital Assistant (PDA), a suitably configured wired or wireless telephone, or any other suitable type of computing device. The client computing device may be functionally associated with an Interactive Voice Response System (IVRS) suitable for entry of the identifying data of the members in the group.

In some embodiments, the identifying data of the members in the group is transmitted from the client computing device to the server, and may be encrypted at the server.

In some embodiments, the identifying data of the members of the group is encrypted at the client computing device, and the encrypted data is then transmitted to the server.

In some embodiments, the method also includes reporting information regarding the comparing and/or the reevaluating. In some embodiments, the reporting includes visually reporting the information, such as by presenting the information on a display. In some embodiments, the display is functionally associated with the client computing device. In some such embodiments, the display forms an integral part of the client computing device.

In some embodiments, the reporting includes reporting the number of members who were removed from the group of people. In some embodiments, the reporting includes additionally reporting which specific members were removed from the group of people. In some embodiments, the reporting includes reporting the number of members remaining in the group of people. In some embodiments, the reporting includes reporting that no members were removed from the group of people.

In some embodiments, the reporting includes reporting the medical information following the reevaluating. In some embodiments, the reporting additionally includes reporting the medical information prior to the reevaluating, possibly alongside the medical information following the recalculating. In some embodiments, the reporting includes reporting that the medical information has not been reevaluated, or does not need to be reevaluated. In some embodiments, the medical information includes results of a clinical trial. In some such embodiments, the member includes a specific participant in the clinical trial. In some embodiments the group of people includes a group of participants in the clinical trial. In some embodiments the group of people also includes a group of participants in another clinical trial. In some such embodiments, the comparing includes comparing the identifying data of the specific participant to the identifying data of each other participant in the clinical trial and/or in another clinical trial. In some embodiments, the member, or specific participant, and at least one other member or participant to whom the specific participant match, are removed from the group of participants only if at least one match exclusion criterion is met.

The match exclusion criterion may be any suitable match exclusion criterion. That said, in some embodiments, the group includes participants of the clinical trial, and the match exclusion criterion includes excluding any duplicate participant—that is any participant who appears more than once in the list of participants of the clinical trial. In some embodiments, the group includes a group of participants in the clinical trial and in other clinical trials, and the match exclusion criterion includes excluding any participant who is already participating in another clinical trial. In some embodiments, the group includes a group of participants in the clinical trial and in other clinical trials, and the match exclusion criterion includes excluding any participant who had participated in another clinical trial within a predetermined period of the clinical trial, such as, for example, excluding any participant who had participated in another clinical trial within a month, six months, or a year of the clinical trial. In some embodiments, the at least one match exclusion criterion includes multiple exclusion criteria. In some such embodiments, the removing includes removing the specific participant and any matching participants from the group if one or more of the exclusion criteria are met.

In some embodiments, the reevaluating includes recalculating the results of the clinical trial, following removal of data relating to the removed participant(s).

In some embodiments, the reporting includes reporting that at least one participant was excluded from the clinical trial. In some such embodiments, the report may also include identifying data of the at least one excluded participant.

In some embodiments, the reporting also includes reporting a reason for exclusion of the at least one participant and/or reporting the at least one match exclusion criterion that was met. For example, the report may state that the potential participant is already enrolled in the clinical trial, was enrolled in another clinical trial during the clinical trial, or participated in another clinical trial which was completed within the predetermined time frame.

In some embodiments, the report may also include the date of enrollment in the clinical trial or in another clinical trial, the date of termination of another clinical trial in which participant had participated, and/or the name of another clinical trial in which the participant had participated.

In some embodiments, the reporting includes reporting the recalculated results of the clinical trial, following removal of data relating to the removed participant(s). In some embodiments, the results are reported alongside the previously calculated results.

In some embodiments, if no participant was removed from the group, the reporting includes reporting that the results of the clinical trial are accurate, and/or need not be recalculated.

In some embodiments, the medical information includes information regarding adverse events caused by a specific drug or pharmaceutical being examined. In some such embodiments, the member includes a specific patient for which an adverse event was reported. In some embodiments, the member includes a patient for which an adverse response to the specific drug was reported. In some embodiments the group of people includes a group of patients for which adverse events were reported. The adverse events may be reported to have been caused by the specific drug and/or by other drugs or pharmaceuticals.

In some such embodiments, the comparing includes comparing the identifying data of the specific patient to the identifying data of each other patient for whom an adverse event was reported. In some such embodiments, the comparing includes comparing the identifying data of the specific patient to the identifying data of each other patient for whom an adverse event caused by the specific drug was reported.

In some embodiments, the specific patient and the at least one other patient having matching identifying data are removed from the group only if at least one match exclusion criterion is met.

The match exclusion criterion may be any suitable match exclusion criterion. That said, in some embodiments, the match exclusion criterion includes the adverse events occurring on the same date. In some embodiments, the match exclusion criterion includes the adverse events occurring within a predetermined time period, such as three days, a week, two weeks, or a month. In some embodiments, the match exclusion criterion includes the adverse events being identified by a single medical practitioner. In some embodiments, the match exclusion criterion includes the adverse events occurring in the same geographic area, or in geographic proximity to one another.

In some embodiments, the at least one match exclusion criterion includes multiple exclusion criteria. In some such embodiments, the removing includes removing the specific patient and any matching patients from the group if one or more of the match exclusion criteria are met.

In some embodiments, the reevaluating includes reassessing the adverse events or side effects caused by the specific drug or pharmaceutical, following removal of data relating to the removed patient(s). In some such embodiments, the reevaluating functions as a method for “cleaning up” the medical information related to the specific drug or pharmaceutical being examined.

In some embodiments, the reporting includes reporting that at least one adverse event relating to at least one patient was excluded from the adverse events caused by the drug or pharmaceutical being examined. In some such embodiments, the report may also include identifying data of the at least one excluded patient.

In some embodiments, the reporting also includes reporting a reason for exclusion of the at least one patient and/or reporting the at least one match exclusion criterion that was met. For example, the report may state that on the same date, an adverse event to the specific patient was reported for the specific drug and for another drug.

In some embodiments, the report may also include the date of the adverse event relating to the removed patient, the name of another drug causing an adverse event to the specific patient was reported, and the date at which the adverse event caused by the other drug had occurred.

In some embodiments, the method may be carried out as a background process, while another process runs in the foreground.

According to an aspect of some embodiments of the invention there is provided a device for improving the accuracy of medical information, including a comparison module configured to compare identifying data of each specific member in a group of people used to determine the medical information at least to identifying data of each other member in the group, and an analysis module functionally associated with the comparison module and configured to remove the specific member and at least one other member in the group from the group of people if the identifying data of the specific member matches identifying data of the at least one other member, and if at least one member was removed from the group of people, notify a user of the removal of the at least one member.

In some embodiments, the analysis module is configured to notify the user of the identity of the at least one member removed from the group of people. In some embodiment, the analysis module is further configured to reevaluate the medical information following removal of the at least one member.

The identifying data may be any suitable identifying data which would assist in uniquely identifying the potential participant. For example, the identifying data may include any or all of first name, last name, initials, number of letters in the first and/or last names, date of birth, place of birth, sex, weight, height, eye color, race, ethnicity, blood type, waist size, hip size, address, national identification number such as a social security number or a passport number, and one or more biometric identifiers of the potential participant, such as one or more of fingerprints, iris prints, hand prints, images suitable for facial recognition, voice print, and the like.

In some embodiments, database includes encrypted data, and the comparison module is configured to compare encrypted identifying data.

In some embodiments, the comparison module forms part of a server, functionally associated with the database.

In some embodiments, the device also includes a data manipulation module, configured to manipulate the identifying data of the member. In some embodiments, the data manipulation module forms part of the server.

In some embodiments, the data manipulation module is configured to create multiple identifying data listings by changing one or more values corresponding to one or more data elements in the identifying data. Typically, the data elements include data elements for which measurement variance or actual variance is likely or common, such as height, weight, and waist and hip circumference measurements. In some embodiment, the data manipulation module is configured to change, in each identifying data listing, a value corresponding to a single identifying data element in the identifying data. In some embodiments, the value includes a height value. In some embodiments, the value includes a weight value. In some embodiments, the value includes a hip circumference measurement. In some embodiments, the value includes a waist circumference measurement.

In some embodiments, the data manipulation module is configured to create multiple identifying data listings while the data is encrypted.

In some embodiments, the data manipulation module is configured to create multiple identifying data listings while the data is not encrypted.

In some such embodiments, the device also includes a decryption module, functionally associated with the data manipulation module, configured to decrypt encrypted identifying data of the member prior to the creation of multiple identifying data listings by the data manipulation module. In some such embodiments, the data manipulation module is functionally associated with an encryption module, configured to re-encrypt the identifying data and to encrypt each of the identifying data listings.

In some embodiments, the comparison module is configured to compare each of the identifying data listings to the identifying data of at least each other member in the group.

In some embodiments, the device also includes a data entry module configured to receive identifying data of each member in the group. In some embodiments, the device also includes an encryption module, functionally associated with the data entry module and configured to encrypt the identifying data of each member in the group.

In some embodiments, the data entry module is functionally associated with an input device, the input device being configured to be used by a user for entering the identifying data. The input device may be any suitable input device, such as a keyboard, a mouse, a microphone, a finger print or retina scanner, a camera, a DNA scanner, or any other suitable input device which may be used by the user to enter data into the data entry module.

The client computing device may be any suitable computing device, such as a desktop computer, a laptop computer, a tablet computer, a mobile telephone such as a smart-phone, a Personal Digital Assistant (PDA), a suitably configured wired or wireless telephone, or any other suitable type of computing device. The client computing device may be functionally associated with an Interactive Voice Response System (IVRS) suitable for entry of the identifying data of the members in the group.

In some embodiments, the identifying data of the members in the group is transmitted from the client computing device to the server, via at least one transceiver.

In some embodiments, the encryption module forms part of the server. In some embodiments, the encryption module forms part of the client computing device. In some such embodiments, the device also includes a second encryption module forming part of the server.

In some embodiments, the analysis module is also configured to report information regarding the comparison of identifying data and/or regarding the recalculation of the medical information. In some such embodiments, the analysis module is functionally associated with a display, and is configured to present the information is to the user on the display. In some embodiments, the display is functionally associated with the client computing device. In some such embodiments, the display forms an integral part of the client computing device.

In some embodiments, the analysis module is configured to report the number of members who were removed from the group of people. In some embodiments, the analysis module is configured to additionally report which specific members were removed from the group of people. In some embodiments, the analysis module is configured to report the number of members remaining in the group of people. In some embodiments, the analysis module is configured to report that no members were removed from the group of people.

In some embodiments, the analysis module is configured to report the medical information following the recalculating. In some embodiments, the analysis module is configured to report the medical information prior to the recalculating, possibly alongside the medical information following the recalculating. In some embodiments, the analysis module is configured to report that the medical information has not been reevaluated, or does not need to be reevaluated.

In some embodiments, the medical information includes results of a clinical trial. In some such embodiments, the member includes a specific participant in the clinical trial. In some embodiments the group of people includes a group of participants in the clinical trial. In some embodiments the group of people also includes a group of participants in another clinical trial. In some such embodiments, the comparison module is configured to compare the identifying data of the specific participant to the identifying data of each other participant in the clinical trial and/or in another clinical trial.

In some embodiments, the member, or specific participant, and the at least one other member or participant to whom the specific participant match, are removed from the group of participants only if at least one match exclusion criterion is met.

The match exclusion criterion may be any suitable match exclusion criterion. That said, in some embodiments, the group includes participants of the clinical trial, and the match exclusion criterion includes excluding any duplicate participant—that is any participant who appears more than once in the list of participants of the clinical trial. In some embodiments, the group includes a group of participants in the clinical trial and in other clinical trials, and the match exclusion criterion includes excluding any participant who is already participating in another clinical trial. In some embodiments, the group includes a group of participants in the clinical trial and in other clinical trials, and the match exclusion criterion includes excluding any participant who had participated in another clinical trial within a predetermined period of the clinical trial, such as, for example, excluding any participant who had participated in another clinical trial within a month, six months, or a year of the clinical trial.

In some embodiments, the at least one match exclusion criterion includes multiple exclusion criteria. In some such embodiments, the analysis module is configured to remove the specific participant and any matching participants from the group if one or more of the exclusion criteria are met.

In some embodiments, the analysis module is configured to reevaluate the medical information by recalculating the results of the clinical trial, following removal of data relating to the removed participant(s).

In some embodiments, the analysis module is configured to report that at least one participant was excluded from the clinical trial. In some such embodiments, the report may also include identifying data identifying the at least one excluded participant.

In some embodiments, the analysis module is configured to report a reason for exclusion of the at least one participant and/or at least one match exclusion criterion that was met. For example, the report may state that the potential participant is already enrolled in the clinical trial, was enrolled in another clinical trial during the clinical trial, or participated in another clinical trial which was completed within the predetermined time frame.

In some embodiments, the report may also include the date of enrollment in the clinical trial or in another clinical trial, the date of termination of another clinical trial in which participant had participated, and/or the name of another clinical trial in which the participant had participated.

In some embodiments, the analysis module is configured to report the recalculated results of the clinical trial, following removal of data relating to the removed participant(s). In some embodiments, the results are reported alongside the previously calculated results.

In some embodiments, if no participant was removed from the group, the analysis module is configured to report that the results of the clinical trial are accurate, and/or need not be recalculated.

In some embodiments, the medical information includes information regarding adverse events caused by a specific drug or pharmaceutical being examined. In some such embodiments, the member includes a specific patient for which an adverse event was reported. In some embodiments, the member includes a patient for which an adverse response to the specific drug was reported. In some embodiments the group of people includes a group of patients for which adverse events were reported. The adverse events may be reported to have been caused by the specific drug and/or by other drugs or pharmaceuticals.

In some such embodiments, the comparison module is configured to compare the identifying data of the specific patient to the identifying data of each other patient for whom an adverse event was reported. In some such embodiments, the comparison module is configured to compare the identifying data of the specific patient to the identifying data of each other patient for whom an adverse event caused by the specific drug was reported.

In some embodiments, the specific patient and the at least one other patient having matching identifying data are removed from the group only if at least one match exclusion criterion is met.

The match exclusion criterion may be any suitable match exclusion criterion. That said, in some embodiments, the match exclusion criterion includes the adverse events occurring on the same date. In some embodiments, the match exclusion criterion includes the adverse events occurring within a predetermined time period, such as three days, a week, two weeks, or a month. In some embodiments, the match exclusion criterion includes the adverse events being identified by a single medical practitioner. In some embodiments, the match exclusion criterion includes the adverse events occurring in the same geographic area, or in geographic proximity to one another.

In some embodiments, the at least one match exclusion criterion includes multiple match exclusion criteria. In some such embodiments, the analysis module is configured to remove the specific patient and any matching patients from the group if one or more of the match exclusion criteria are met.

In some embodiments, the analysis module is configured to reevaluate the medical information by reassessing the adverse events or side effects caused by the specific drug or pharmaceutical, following removal of data relating to the removed patient(s). In some such embodiments, the recalculating functions as a method for “cleaning up” the medical information related to the specific drug or pharmaceutical being examined.

In some embodiments, the analysis module is configured to report that at least one adverse event relating to at least one patient was excluded from the adverse events caused by the drug or pharmaceutical being examined. In some such embodiments, the report may also include identifying data for the at least one excluded patient.

In some embodiments, the analysis module is configured to report a reason for exclusion of the at least one patient and/or the at least one match exclusion criterion that was met. For example, the report may state that on the same date, an adverse event to the specific patient was reported for the specific drug and for another drug.

In some embodiments, the report may also include the date of the adverse event relating to the removed patient, the name of another drug causing an adverse event to the specific patient was reported, and the date at which the adverse event caused by the other drug had occurred.

In some embodiments, at least one of the comparison module and the analysis module includes a software process, the software process running in the background while another process runs in the foreground.

Unless otherwise defined, all technical and scientific terms used herein have the same meaning as commonly understood by one of ordinary skill in the art to which the invention pertains. In case of conflict, the specification, including definitions, will take precedence.

As used herein, the terms “including”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

As used herein, the indefinite articles “a” and “an” mean “at least one” or “one or more” unless the context clearly dictates otherwise.

As used herein, when a numerical value is preceded by the term “about”, the term “about” is intended to indicate +/−10%.

Embodiments of methods and/or devices of the invention may involve performing or completing selected tasks manually, automatically, or a combination thereof. Some embodiments of the invention are implemented with the use of components that include hardware, software, firmware or combinations thereof. In some embodiments, some components are general-purpose components such as general purpose computers or monitors. In some embodiments, some components are dedicated or custom components such as circuits, integrated circuits or software.

For example, in some embodiments, some of an embodiment is implemented as a plurality of software instructions executed by a data processor, for example which is part of a general-purpose or custom computer. In some embodiments, the data processor or computer includes volatile memory for storing instructions and/or data and/or a non-volatile storage, for example, a magnetic hard-disk and/or removable media, for storing instructions and/or data. In some embodiments, implementation includes a network connection. In some embodiments, implementation includes a user interface, generally including one or more of input devices (e.g., allowing input of commands and/or parameters) and output devices (e.g., allowing reporting parameters of operation and results.

### BRIEF DESCRIPTION OF THE DRAWINGS

Some embodiments of the invention are described herein with reference to the accompanying drawings. The description, together with the drawings, makes apparent to a person having ordinary skill in the art how some embodiments of the invention may be practiced. The drawings are for the purpose of illustrative discussion and no attempt is made to show structural details of an embodiment in more detail than is necessary for a fundamental understanding of the invention. For the sake of clarity, some objects depicted in the drawings are not to scale.

In the drawings:

FIG. 1 is a block diagram of a system for improving medical information and/or for identifying improper participation in a clinical trial according to an embodiment of the teachings herein;

FIGS. 2A and 2B, taken together, are a flow chart of an embodiment of a method for preventing improper participation in a clinical trial at the time of registration to the clinical trial, according to an embodiment of the teachings herein;

FIGS. 3A and 3B, taken together, are a flow chart of an embodiment of a method for retroactively accounting for improper participation in a clinical trial, according to an embodiment of the teachings herein; and

FIGS. 4A and 4B, taken together, are a flow chart of an embodiment of a method for improving drug adverse event reporting for drugs and/or pharmaceuticals, according to an embodiment of the teachings herein.

### DETAILED DESCRIPTION

The invention, in some embodiments, relates to the field of clinical trials and reporting, and more specifically to finding duplicate medical reporting in clinical trials or when reporting adverse events attributed to drug use.

The invention, in some embodiments, relates to the field of clinical trials, and more particularly to methods and devices for improving the results of clinical trials by preventing improper participation in clinical trials.

The principles, uses and implementations of the teachings herein may be better understood with reference to the accompanying description and drawings. Upon perusal of the description and drawings present herein, one skilled in the art is able to implement the invention without undue effort or experimentation.

Before explaining at least one embodiment of the invention in detail, it is to be understood that the invention is not limited in its applications to the details of construction and the arrangement of the components and/or methods set forth in the following description and/or illustrated in the drawings and/or the Examples. The invention can be implemented with other embodiments and can be practiced or carried out in various ways. It is also understood that the phraseology and terminology employed herein is for descriptive purpose and should not be regarded as limiting.

In the context of the following disclosure, a potential participant is person who may be included in a clinical trial based on the commonly used exclusion and inclusion criteria. For example, a person would not be considered a potential participant, if any one or more of the following apply:
the person is not in a suitable age range;
the person has severe and/or non-related preexisting medical conditions;
the person is a female who is pregnant and/or breastfeeding or is not practicing contraception;
the person is a substance abuser; and
the person is unable to understand or to provide informed consent.

According to an aspect of some embodiments of the invention there is provided a method for identifying improper participation in a clinical trial, including receiving identifying data for an individual, comparing the received identifying data of the individual to identifying data of clinical trial participants included in a clinical trial participant database, and if the identifying data of the potential participant matches identifying data of a specific clinical trial participant in the database, providing exclusion data identifying the individual for exclusion from the clinical trial.

According to an aspect of some embodiments of the invention there is provided a device for identifying improper participation in a specific clinical trial, including a clinical trial participant database including identifying data of participants in at least one clinical trial, a data entry module configured to receive identifying data of an individual, a comparison module configured to compare the identifying data of the individual to identifying data of clinical trial participants in the clinical trial participant database, and an analysis module, functionally associated with the comparison module, and configured to receive comparison results of the comparison module and to provide exclusion data identifying the individual for exclusion from the specific clinical trial if the identifying data of the individual matches identifying data of a specific clinical trial participant in the database.

According to an aspect of some embodiments of the invention there is provided a method for improving the accuracy of medical information, including, for each member in a group of people used to determine the medical information, obtaining identifying data of the member, comparing the obtained identifying data of the member at least to identifying data of each other member in the group of people, and if the obtained identifying data of the member matches identifying data of at least one other member in the group, removing the member and the at least one other member from the group of people, and if at least one member was removed from the group of people, notifying a user of the removal of the at least one member from the group of people.

According to an aspect of some embodiments of the invention there is provided a device for improving the accuracy of medical information, including a comparison module configured to compare identifying data of each specific member in a group of people used to determine the medical information at least to identifying data of each other member in the group, and an analysis module functionally associated with the comparison module and configured to remove the specific member and at least one other member in the group from the group of people if the identifying data of the specific member matches identifying data of the at least one other member, and if at least one member was removed from the group of people, notify a user of the removal of the at least one member.

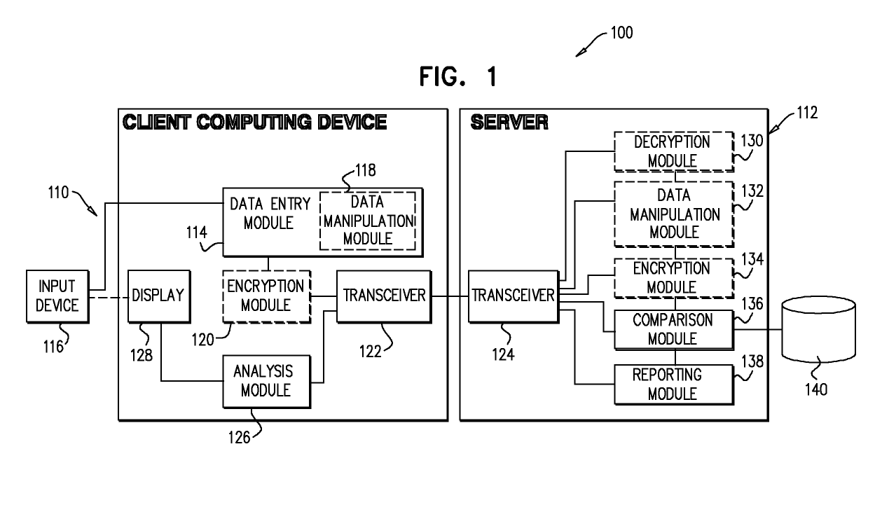

Reference is now made to FIG. 1, which is a block diagram of a system 100 for improving medical information, such as the results of a clinical trial or the specification of adverse events attributed to a pharmaceutical, and/or for identifying improper participation in a clinical trial according to an embodiment of the teachings herein.

As seen in FIG. 1, the system 100 includes a client computing device 110, which is typically used by a user of the system 100, and a server 112, at which most of the computation is typically carried out.

The client computing device may be any suitable computing device, such as a desktop computer, a laptop computer, a tablet computer, a mobile telephone such as a smart-phone, a Personal Digital Assistant (PDA), a suitably configured wired or wireless telephone, or any other suitable type of computing device. The client computing device may be functionally associated with an Interactive Voice Response System (IVRS) suitable for entry of the identifying data of people.

As seen, client computing device 110 includes a data entry module 114 functionally associated with one or more input devices 116, such as a keyboard, a mouse, a microphone, a finger print or retina scanner, a camera, a DNA scanner, or any other suitable input device which may be used by the user to enter data into the data entry module 114. Data entry module may, in some embodiments, include a data manipulation module 118 for manipulation of data entered thereinto.

In some embodiments, client computing device 110 includes an encryption module 120 functionally associated with data entry module 114, though in other embodiments encryption module 120 may be obviated.

Data entry module 114 and/or encryption module 120 are functionally associated with a client transceiver 122 forming part of client computing device 110, which in turn is functionally associated with a server transceiver 124 forming part of server 112.

Client computing device 110 further includes an analysis module 126 functionally associated with client transceiver 122 and with a display 128. In some embodiments, display 128 is functionally associated with input device 116, such that data entered using input device 116 is rendered on display 128.

Server 112 includes a decryption module 130, a data manipulation module 132, an encryption module 134, a comparison module 136, and a reporting module 138.

Comparison module 136 is functionally associated with a database 140 and with reporting module 138.

At least one of decryption module 130, data manipulation module 132, encryption module 134, and comparison module 136, as well as reporting module 138, are functionally associated with server transceiver 124. Depending on the specific structure of system 100, typically only one of decryption module 130, data manipulation module 132, encryption module 134, and comparison module 136 are functionally associated with server transceiver 124.

As described in further detail hereinbelow, any or all of decryption module 130, data manipulation module 132, and encryption module 134 may be obviated from server 112.

Typically, system 100 would include either data manipulation module 118 or data manipulation module 132, but not both.

Typically, system 100 would include at least one of encryption modules 120 and 134, and possibly both.

Typically, system 100 includes decryption module 130 only if it also includes encryption module 120. However, even if system 100 includes encryption module 120, decryption module 130 need not necessarily be included. Additionally, if decryption module 130 is included, then system 100 must also include encryption module 134.

If system 100 does not include data manipulation module 132, it typically also does not include decryption module 130.

When decryption module 130 is included in server 112, module 130 is functionally associated with server transceiver 124 and with data manipulation module 132, which in turn is functionally associated with encryption module 134.

In embodiments in which decryption module 130 is obviated, if data manipulation module 132 is included in server 112, data manipulation module 132 is functionally associated with server transceiver 124 and with one of encryption module 134 and comparison module 136.

In embodiments in which data manipulation module 132 is obviated, encryption module 134 is functionally associated with server transceiver 124 and with comparison module 136. In embodiments in which both data manipulation 132 and encryption module 134 are obviated from server 112, comparison module 136 is functionally associated with server transceiver 124.

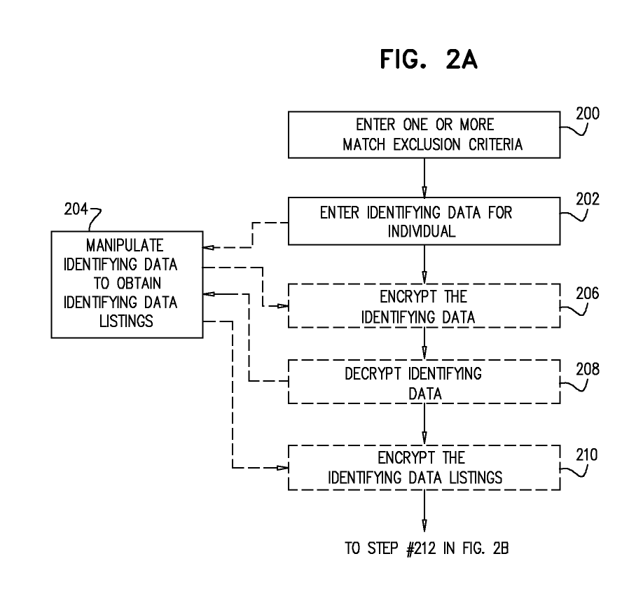

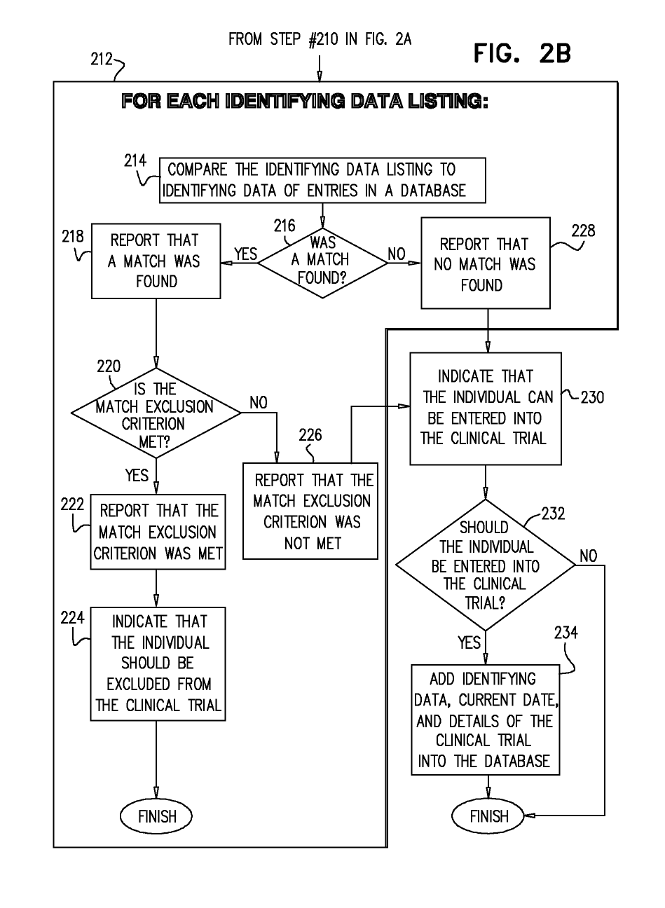

Various uses of system 100 are described in detail hereinbelow with reference to FIGS. 2A-4B.

In use, a user enters identifying data, and possibly other data such as medical data or decision making criteria, into data entry module 114, typically via input device 116. In some embodiments, the data is manipulated by data manipulation module 118 while within data entry module 114. Data manipulation is described in further detail hereinbelow with reference to FIGS. 2A-4B.

In some embodiments, at least part of the data entered into data entry module 114, and specifically identifying data and other data relating to a specific person, is encrypted while in the client computing device by encryption module 120, and is then transferred to client transceiver 122 for transmission to server 112. In other embodiments, such as when encryption module 120 is obviated from client computing device 110, the data is transferred to client transceiver 122 for transmission to server 112 without being encrypted.

The data transmitted from client transceiver 122 is received by server transceiver 124, and from there is transferred to one of the modules of server 112, depending on the specific embodiments.

In embodiments in which the identifying data was not manipulated by data manipulation module 118 of client computing device 110, the data received by server transceiver 124 is transmitted to data manipulation module 132 for manipulation thereof. In some embodiments, if the data was encrypted by encryption module 120, the data is decrypted by data decryption module 130 prior to arriving at data manipulation module 132.

In some embodiments, in which the data is decrypted prior to manipulation thereof or in which the data is not encrypted prior to manipulation thereof by data manipulation module 132, the manipulated data is encrypted, or re-encrypted by encryption module 134.

Additionally, in some embodiments, even if the data was manipulated and encrypted at client computing device 110, the data is transferred from server transceiver 124 to encryption module 134 where it is encrypted a second time.

The data is transferred from one of data manipulation module 132, encryption module 134, and server transceiver 124 to comparison module 136, which is configured to compare the received data with identifying data entries contained in database 140.

The comparison output of comparison module 136 is transferred to reporting module 138, which is configured to arrange the comparison output as a comparison report to be provided to client computing device 110. The report is transmitted to analysis module 126 via server transceiver 124 and client transceiver 122.

Analysis module 126 is configured to analyze the comparison report received from reporting module 138, and to generate a report to be provided to the user, for example by visually rendering the report on display 128. In some embodiments, analysis module 126 is configured to apply logical rules and/or match exclusion criteria based on the information included in the comparison report. In some embodiments, analysis module 126 is configured to revise or recalculate medical information based on one or more comparison reports received from server 112.

In some embodiments, one or more of data manipulation module 118, encryption module 120, decryption module 130, data manipulation module 132, encryption module 134, comparison module 136, reporting module 138, and analysis module 126 comprise software threads, configured to be run as a background processes. It is appreciated that in some such embodiments, the background process may communicate with Electronic Data Capture (EDC) systems, Clinical Trial Management Systems (CTMS), Interactive Voice Response (IVRS), IXRS, and/or other types of Interactive Response Technology (IRT) used to collect the personal data, such that the data is automatically transmitted to the system 100, and is processed thereby in the background. In some embodiments, in order to provide suitable data to the system 100, the data collection process, such as EDC, CTMS, IVRS, IXRS, or IRT, may collect more information that normally required, such that some of that information would be transferred directly to system 100, without being stored by the data collection process.

Reference is now made to FIGS. 2A and 2B, which, taken together, are a flow chart of an embodiment of a method for preventing improper participation in a clinical trial at the time of registration to the clinical trial or when screening individuals for participation in the clinical trial, according to an embodiment of the teachings herein. As described hereinbelow, the method of FIGS. 2A and 2B may be implemented using system 100 of FIG. 1.

The method of FIGS. 2A and 2B is typically carried out by a user, such as a medical professional, seeking to enroll an individual in a clinical trial, and/or to make sure that the individual should indeed be included in the clinical trial.

As seen at reference numeral 200 in FIG. 2A, the user enters one or more match exclusion criteria, based on which it will be determined whether or not an individual should be excluded from the clinical trial.

The match exclusion criterion may be any suitable match exclusion criterion. That said, in some embodiments, a match exclusion criterion comprises excluding any individual who is already participating in the current clinical trial. In some embodiments, a match exclusion criterion comprises excluding any individual who is already participating in a clinical trial other than the current clinical trial. In some embodiments, a match exclusion criterion comprises excluding any individual who has participated in another clinical trial within a predetermined period of the current clinical trial, such as, for example, excluding any individual who has participated in another clinical trial which had completed a year, six months, a month, or a week prior to the enrollment or commencement of the current clinical trial.

At reference numeral 202, the user enters identifying data for a specific individual in the clinical trial.

The identifying data may be any suitable identifying data which would assist in uniquely identifying a person for which data is entered. For example, the identifying data may include any or all of first name, last name, initials, number of letters in the first and/or last names, date of birth, place of birth, sex, weight, height, eye color, race, ethnicity, blood type, waist size, hip size, address, national identification number such as a social security number or a passport number, and one or more biometric identifiers of the individual, such as one or more of fingerprints, iris prints, hand prints, images suitable for facial recognition, voice print, DNA snips, DNA signature, and the like.

In some embodiments, the user enters the exclusion criteria and/or the identifying data using an input device, such as input device 116 of FIG. 1, and the entered information is received in a data entry module such as data entry module 114 of FIG. 1. In other embodiments, the identifying data of the individual and/or the exclusion criterion are received by the data entry module, for example via a network connection with another computer.

In some embodiments, immediately following user entry of the identifying data, the identifying data is manipulated by a data manipulation module, such as modules 118 and 132 of FIG. 1, to obtain identifying data listings, as seen at reference numeral 204. The identifying data typically contains multiple elements, such as first name, last name, sex, height, weight, and date of birth. In some embodiments, the identifying data listings are created by duplicating the identifying data to obtain multiple identifying data listings, and in each listing changing one or more values corresponding to one or more of the data elements. Typically, the values are changed in data elements for which measurement variance or actual variance is likely or common, such as height, weight, and waist and hip circumference measurements. By creating the identifying data listings, the system accounts for slight variations in measurement, thereby ensuring that duplicate participation in the clinical trial will be identified even if the values entered for some of the data entries are not identical.

The identifying data, as well as the identifying data listings, if such were created, may then be encrypted, as seen at reference numeral 206. The encryption may be carried out at a client computing device, such as at encryption module 120 of FIG. 1, or at a server, such as at encryption module 134 of FIG. 1.

Typically, the identifying data and, if created, the identifying data listings are transmitted from the user device used by the user to enter the identifying data, such as client computing device 110, to a dedicated server, such as server 112. In some embodiments, in order to ensure the privacy of the individual, the encryption step 206 may take place prior to transmission of the identifying data from the user device to the server.

In some embodiments, in which identifying data listings were not created prior to encryption of the data, the identifying data may be manipulated at step 204 following encryption of the identifying data.

In some embodiments, the data is manipulated at step 204 while it is encrypted.

In some embodiments, as seen at reference numeral 208, the identifying data is decrypted by a decryption module, such as module 130 of FIG. 1, and is then manipulated at step 204, when unencrypted.

Following manipulation of the data, at step 210 the identifying data listings may be encrypted by an encryption module, such as encryption module 134 of FIG. 1. In embodiments in which the identifying data was decrypted at step 208, the identifying data may be re-encrypted at step 210. In some embodiments in which the identifying data was not decrypted at step 208, the identifying data (and identifying data listings) may be encrypted a second time, to further secure the privacy of the participant's personal information.

Turning to FIG. 2B, once the identifying data listings have been created and, in some embodiments, are securely encrypted, the comparison phase, in which duplicate participation in clinical trials may be determined, may begin.

As seen at step 212, the following sub-steps are carried out for each identifying data listing.

At step 214, the identifying data listing is compared to identifying data of clinical trial participants, by a comparison module such as module 136 of FIG. 1. The identifying data of clinical trial participants is stored in a database, such as database 140 of FIG. 1, which is functionally associated with the comparison module. Typically, each entry in the clinical trial participant database includes identifying data regarding the participant, and a name, and start and end date of the clinical trial in which the participant participated. In some embodiments, the entry includes additional information, such as contact information for the participant, contact information for the party conducting the clinical trial, and contact information for a medical professional who enrolled the participant in the clinical trial. In some embodiments, in each such entry, the identifying data is encrypted.

In some embodiments, if the identifying data in the database is encrypted, the identifying data of the individual is also encrypted, and the identifying data is compared while encrypted.

At step 216, the output of the comparison module indicates whether or not the identifying data listing matched any identifying data in the database. If a match was found, the finding of such a match is reported at step 218, typically via one or more of a reporting module, such as reporting module 138 of FIG. 1, which reports the raw results of the comparison. In some embodiments the report may be received by an analysis module such as module 126 of FIG. 1, and may be presented to the user on a display, such as display 128 of FIG. 1.

Subsequently, at step 220, the one or more match exclusion criteria are evaluated, such as by the analysis module. As seen at step 222, the user receives a report, such as a visual report rendered on the display, if one or more of the match exclusion criteria are met. The user then receives an indication, which may be a visual indication rendered on the display, or any other suitable type of indication, that the individual should be excluded from the clinical trial, at step 224.

If none of the match exclusion criteria were met, at step 226 the user receives a report, such as a visual report rendered on the display, that none of the match criteria were met. Returning to step 216, if no match was found, the user receives a report, such as a visual report rendered on the display, that no match was found for the compared identifying data listing, at step 228. Following step 226 and/or step 228, steps 214-228 are repeated for another identifying data listing.

Once all the identifying data listings have been compared to the identifying data of other clinical trial participants stored in the database, if for each identifying data listing no match was found and/or no match exclusion criterion was met, the analysis module indicates to the user that the individual may be entered into the clinical trial, at step 230. The indication may be in the form of a visual indication rendered on the display, as an audible indication, or as any other suitable type of indication.

In some embodiments, the user is then asked whether to enter the individual as a participant in the clinical trial, at step 232. If the user wishes to enter the individual as a participant in the clinical trial, the identifying data, date, and details of the clinical trial are added to the database at step 234.

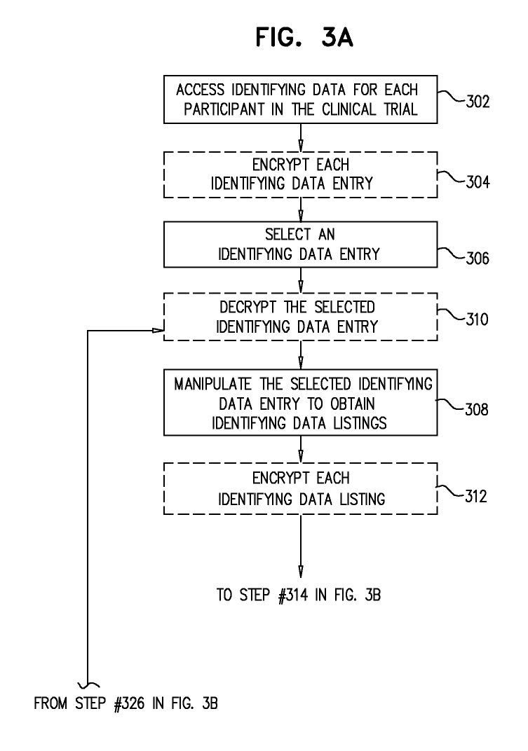

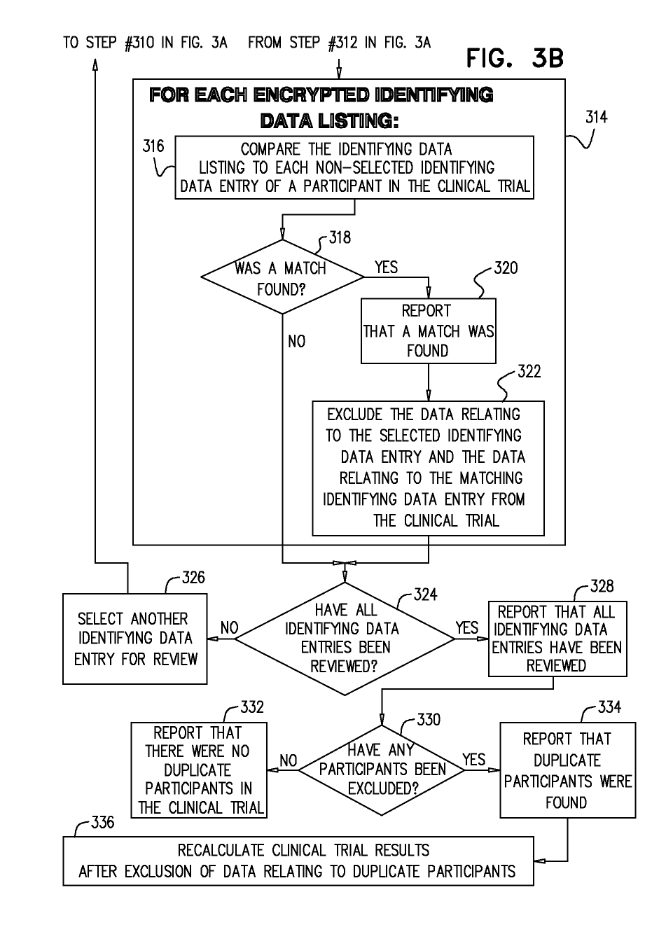

Reference is now made to FIGS. 3A and 3B, which, taken together, are a flow chart of an embodiment of a method for retroactively accounting for improper participation in a clinical trial, according to an embodiment of the teachings herein. As described hereinbelow, the method of FIGS. 3A and 3B may be implemented using system 100 of FIG. 1.

The method of FIGS. 3A and 3B is typically carried out by a user, such as a medical professional, seeking to ensure and/or improve the accuracy of the results of a clinical trial by removal of data relating to duplicate participants from the data used to compute the clinical trial results.

At reference numeral 302, the user enters identifying data for each participant in the clinical trial. In some embodiments, the user enters the identifying data using an input device, such as input device 116 of FIG. 1, and the entered information is received in a data entry module such as data entry module 114 of FIG. 1. In other embodiments, the user enters the identifying data by uploading data from a batch file containing participant data directly to the data entry module, such as by using IVRS.

The identifying data may be any suitable identifying data which would assist in uniquely identifying a person for which data is entered. For example, the identifying data may include any or all of first name, last name, initials, number of letters in the first and/or last names, date of birth, place of birth, sex, weight, height, eye color, race, ethnicity, blood type, waist size, hip size, address, national identification number such as a social security number or a passport number, and one or more biometric identifiers of the potential participant, such as one or more of fingerprints, iris prints, hand prints, images suitable for facial recognition, voice print, DNA snips, DNA signature, and the like.

The identifying data of each of the participants may then be encrypted, as seen at reference numeral 304. The encryption may be carried out at a client computing device, such as at encryption module 120 of FIG. 1, or at a server, such as at encryption module 134 of FIG. 1.

Typically, the identifying data is transmitted from the user device used by the user to enter the identifying data, such as client computing device 110, to a dedicated server, such as server 112. In some embodiments, in order to ensure the privacy of the potential participant, the encryption step 304 takes place prior to transmission of the identifying data from the user device to the server.

As seen at reference numeral 306, one of the identifying data entries is selected for review and for comparison with identifying data of other participants.

The selected identifying data entry is manipulated by a data manipulation module, such as modules 118 and 132 of FIG. 1, to obtain identifying data listings, as seen at reference numeral 308. The identifying data typically contains multiple elements, such as first name, last name, sex, height, weight, and date of birth. In some embodiments, the identifying data listings are created by duplicating the identifying data to obtain multiple listing, and in each listing changing one or more values corresponding to one or more of the data elements. Typically, the values are changed in data elements for which measurement variance or actual variance is likely or common, such as height, weight, and waist and hip circumference measurements. By creating the identifying data listings, the system accounts for slight variations in measurement, thereby ensuring that duplicate participation in the clinical trial will be identified even if the values entered for some of the data entries are not identical.

In some embodiments, the data is manipulated at step 308 while it is encrypted.

In some embodiments, as seen at reference numeral 310, the selected identifying data is decrypted by a decryption module, such as module 130 of FIG. 1, prior to being manipulated, and is then manipulated at step 308, when unencrypted.

Following manipulation of the data, if the identifying data listings are not encrypted, at step 312 the identifying data listings may be encrypted by an encryption module, such as encryption module 134 of FIG. 1. In embodiments in which the identifying data was decrypted at step 310, the identifying data may be re-encrypted at step 312. In some embodiments in which the identifying data was not decrypted at step 310, the identifying data (and identifying data listings) may be encrypted a second time, to further secure the privacy of the participant's personal information.

It is appreciated that in some embodiments, manipulation of the identifying data for each participant to create identifying data listings occurs immediately following entry of the identifying data at step 302, and prior to encryption of the identifying data. In such embodiments, steps 308 and 310 are obviated, and step 312 may be obviated or may be used to further secure the privacy of the participants' information.

Turning to FIG. 3B, once the identifying data listings for the selected identifying data have been created, the comparison phase, in which duplicate participation in clinical trials is determined, may begin.

As seen at step 314, the following sub-steps are carried out for each identifying data listing.

At step 316, the identifying data listing is compared to each non-selected identifying data entry of a participant in the clinical trial, by a comparison module such as module 136 of FIG. 1.

At step 318, the output of the comparison module indicates whether or not the identifying data listing matched any non-selected identifying data entry. If a match was found, the finding of such a match is reported at step 320, typically via one or more of a reporting module, such as reporting module 138 of FIG. 1. In some embodiments the report may be received by an analysis module such as module 126 of FIG. 1, and may be presented to the user on a display, such as display 128 of FIG. 1. In some embodiments, the data relating to the selected identifying data entry and to the matching identifying data entry or entries are excluded from the data used to compute the results of the clinical trial, as seen at reference numeral 322.

Subsequently, or if no match was found at step 318, the identifying data entries for all the participants in the clinical trial are evaluated to see whether any of the data entries have not yet been selected for comparison and the data therein has not been compared to data of other participants, at step 324.

If at least one identifying data entry had not been reviewed and compared to identifying data of other participants, a new identifying data entry is selected for comparison and review at step 326, and steps 310-324 are repeated with the newly selected identifying data entry.

If all the identifying data entries had been selected for comparison, at step 328 the user receives a report, such as a visual report rendered on the display, that all the identifying data entries were reviewed.

At step 330, the number of participants who had been excluded is evaluated, typically by the analysis module. If no data relating to participants of the clinical trial was excluded, the user receives a report that no duplicate participants were found in the clinical trial, at step 332.

If, on the other hand, data relating to one or more participants had been excluded from the data of the clinical trial, the user receives a report that duplicate participants were found in the clinical trial, at step 334, and, in some embodiments, the results of the clinical trial are recalculated following exclusion of the data relating to the duplicate participants, at step 336.

In some embodiments, data relating to a duplicate participant may be excluded from the data of the clinical trial if one or more additional match exclusion criteria are met. For example, the participant may be excluded if he was participating in another clinical trial concurrently with the clinical trial being evaluated, or in another clinical trial that ended shortly before commencement of the clinical trial being evaluated. In embodiments in which participation in another clinical trial is a match exclusion criterion, at step 316, the identifying data listing is compared to identifying data entries in a database of clinical trial participants, such as database 140 of FIG. 1, which database includes information relating to participants in a plurality of clinical trials.

In some such embodiments, following step 320 in which a match is found and is reported, and prior to step 322 in which the data relating to the matching participants is excluded from the data of the clinical trial, the one or more match exclusion criteria are evaluated, and the data is excluded from the data of the clinical trial only if one or more of the match exclusion criteria are met.

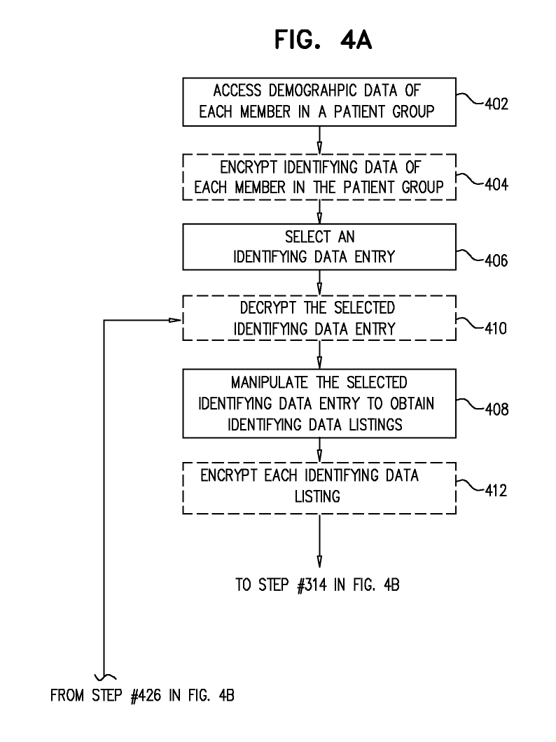

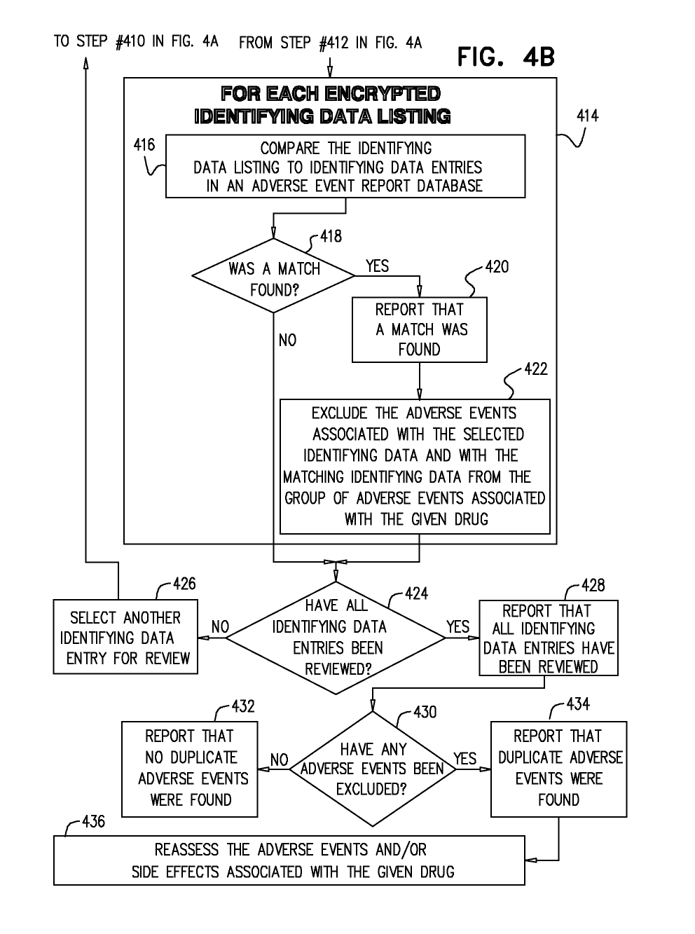

Reference is now made to FIGS. 4A and 4B, which, taken together, are a flow chart of an embodiment of a method for improving drug adverse event reporting for drugs and/or pharmaceuticals, according to an embodiment of the teachings herein. As described hereinbelow, the method of FIGS. 4A and 4B may be implemented using system 100 of FIG. 1.

It is appreciated that the terms ‘drug’ and pharmaceutical are used interchangeably herein, such that each occurrence of the term ‘drug’ and each occurrence of the term ‘pharmaceutical’ refer to ‘drug and/or pharmaceutical’.

The method of FIGS. 4A and 4B is typically carried out by a user, such as an employee at a pharmaceutical company, seeking to improve the accuracy of side effects and/or adverse events reported for a given drug by removal of data relating to duplicate reporting of a single adverse effect. The duplicate reporting may comprise multiple reports linking an adverse event with the given drug, or reports linking the adverse event with the given drug as well as with other drugs or pharmaceuticals.

At reference numeral 402, the user accesses identifying data for each member in a patient group including patients treated with the given drug for whom one or more adverse events were reported in relation to the given drug. In some embodiments, the user accesses identifying data already stored on a computing device, a server, or in a database. In some embodiments, the user enters the identifying data using an input device, such as input device 116 of FIG. 1, and the entered information is received in a data entry module such as data entry module 114 of FIG. 1. In other embodiments, the user enters the identifying data by uploading data from a batch file containing patient data directly to the data entry module, or by IVRS.

The identifying data may be any suitable identifying data which would assist in uniquely identifying a person for which data is entered. For example, the identifying data may include any or all of first name, last name, initials, number of letters in the first and/or last names, date of birth, place of birth, sex, weight, height, eye color, race, ethnicity, blood type, waist size, hip size, address, national identification number such as a social security number or a passport number, and one or more biometric identifiers of the potential participant, such as one or more of fingerprints, iris prints, hand prints, images suitable for facial recognition, voice print, DNA snips, DNA signature, and the like.

If the identifying data of the members of the patient group is not already encrypted, each identifying data entry for each member in the patient group may be encrypted, as seen at reference numeral 404. The encryption may be carried out at a client computing device, such as at encryption module 120 of FIG. 1, or at a server, such as at encryption module 134 of FIG. 1.

Typically, the identifying data is transmitted from the user device used by the user to enter the identifying data, such as client computing device 110, to a dedicated server, such as server 112. In some embodiments, in order to ensure the privacy of the potential participant, the encryption step 404 takes place prior to transmission of the identifying data from the user device to the server.

As seen at reference numeral 406, one of the identifying data entries is selected for review and for comparison to identifying data entries of other members in the patient group.

The selected identifying data entry is manipulated by a data manipulation module, such as modules 118 and 132 of FIG. 1, to obtain identifying data listings, as seen at reference numeral 408. The identifying data typically contains multiple elements, such as first name, last name, sex, height, weight, and date of birth. In some embodiments, the identifying data listings are created by duplicating the identifying data to obtain multiple listing, and in each listing changing one or more values corresponding to one or more of the data elements. Typically, the values are changed in data elements for which measurement variance or actual variance is likely or common, such as height, weight, and waist and hip circumference measurement. By creating the identifying data listings, the system accounts for slight variations in measurement, thereby ensuring that duplicate reporting of adverse events will be identified even if the values entered for some of the data entries are not identical.

In some embodiments, the data is manipulated at step 408 while it is encrypted.

In some embodiments, as seen at reference numeral 410, the selected identifying data is decrypted by a decryption module, such as module 130 of FIG. 1, prior to being manipulated, and is then manipulated at step 408, when unencrypted.

Following manipulation of the data, if the identifying data listings are not encrypted, at step 412 the identifying data listings may be encrypted by an encryption module, such as encryption module 134 of FIG. 1. In embodiments in which the identifying data was decrypted at step 410, the identifying data may be re-encrypted at step 412. In some embodiments in which the identifying data was not decrypted at step 410, the identifying data (and identifying data listings) may be encrypted a second time, to further secure the privacy of the participant's personal information.

It is appreciated that in some embodiments, manipulation of the identifying data for each member in the patient group to create identifying data listings occurs immediately following accessing of the identifying data at step 402, and prior to encryption of the identifying data. In such embodiments, steps 408 and 410 are obviated, and step 412 may be obviated or may be used to further secure the privacy of the patients' information.

Turning to FIG. 4B, once the identifying data listings for the selected identifying data have been created, the comparison phase, in which duplicate reporting of adverse events is identified, may begin.

As seen at step 414, the following sub-steps are carried out for each identifying data listing.

At step 416, the identifying data listing is compared to identifying data entries of patients for whom adverse events were reported, by a comparison module such as module 136 of FIG. 1. Typically, the identifying data entries are found in an adverse event report database, such as database 140 of FIG. 1. Each entry in the adverse event report database includes the identifying data of a patient who suffered the adverse event, the date of occurrence of the adverse event, and the name of a drug or pharmaceutical in relation to which the adverse event was reported. In some embodiments, the entry also includes the name and/or contact information of the medical professional who reported the adverse event.

At step 418, the output of the comparison module indicates whether or not the identifying data listing matched any identifying data entry in the adverse events report database. If a match was found, the finding of such a match is reported at step 420, typically via one or more of a reporting module, such as reporting module 138 of FIG. 1. In some embodiments the report may be received by an analysis module such as module 126 of FIG. 1, and may be presented to the user on a display, such as display 128 of FIG. 1. In some embodiments, the adverse events associated with the selected identifying data entry and with the matching identifying data entry or entries are excluded from the group of adverse events associated with the given drug, as seen at reference numeral 422.

Subsequently, or if no match was found at step 418, the identifying data entries for the members in the patient group are evaluated to see whether any of the data entries of members in the patient group have not yet been selected for comparison and the data therein has not been compared to data of other members in the group, at step 424.

If at least one identifying data entry had not been reviewed, another identifying data entry is selected for review at step 426, and steps 410-424 are repeated with the newly selected identifying data entry.

If all the identifying data entries had been reviewed, at step 428 the user receives a report, such as a visual report rendered on the display, that all the identifying data entries were reviewed.

At step 430, the number of adverse events which had been excluded from the group of adverse events at step 422 is evaluated, typically by the analysis module. If no adverse event was excluded, the user receives a report that no duplicate adverse events were found, at step 432.

If, on the other hand, at least one adverse event was excluded from the group of adverse events associated with the given drug, the user receives a report that duplicate reports of adverse events were found, at step 434, and, in some embodiments, the adverse events or side effects associated with the given drug are reassessed, automatically or manually as known in the art, at step 436.

In some embodiments, duplicate adverse events may be excluded from group of adverse events associated with the given drug if one or more additional match exclusion criteria are met. For example, the matching adverse events are excluded only if they occurred on the same date. In some embodiments, the matching adverse events are excluded only if they occurred within a predetermined time period of one another, such as three days, a week, two weeks, or a month. In some embodiments, the matching adverse events are excluded only if they were identified by a single medical practitioner. In some embodiments, the matching adverse events are excluded only if they were identified by different medical practitioners. In some embodiments, the matching adverse events are excluded only if they were identified in geographical proximity to one another, or in the same geographical region.

In some such embodiments, following step 420 in which a match is found and is reported, and prior to step 422 in which the duplicate adverse events are excluded from the group of adverse events associated with the given drug, the one or more match exclusion criteria are evaluated, and the adverse event is excluded from the group of adverse events associated with the given drug only if one or more of the match exclusion criteria are met.

It is a particular advantage of the present invention that the identifying data and/or other data may be encrypted and may remain encrypted throughout the process, thereby allowing the protection of the privacy of clinical trial participants and/or of patients, and allowing the protection of information which is sensitive to drug companies, such as the number of participants in an ongoing clinical trial, or the specific list of adverse events reported for a given drug or pharmaceutical.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

What is claimed is:

1. A method for identifying duplicate participation in a specific clinical trial, comprising:
receiving identifying data for an individual;
comparing said received identifying data of said individual to identifying data of clinical trial participants included in a clinical trial participant database; and
if said identifying data of said individual matches identifying data of a specific clinical trial participant in said database, providing exclusion data identifying said individual for exclusion from said clinical trial.

2. The method of claim 1, wherein said receiving identifying data is carried out using a data collecting process, and said comparing is carried out using a data comparison process running as a background process.

3. The method of claim 2, wherein said data collecting process comprises a process running as part of a dedicated data collecting system including at least one of an Electronic Data Capture (EDC) system, a Clinical Trial Management System (CTMS), and an Interactive Response Technology (IRT) system.

4. A method for improving the accuracy of medical information, comprising:
for each member in a group of people used to determine said medical information:
obtaining identifying data of said member;
comparing said obtained identifying data of said member at least to identifying data of each other member in said group of people; and
if said obtained identifying data of said member matches identifying data of at least one other member in said group, removing said member and said at least one other member from said group of people; and
if at least one member was removed from said group of people, notifying a user of said removing said at least one member from said group of people.

5. The method of claim 4, further comprising reevaluating said medical information following said removal of said at least one member.

6. The method of claim 4, also comprising manipulating said obtained identifying data of said member, said manipulating comprising creating multiple identifying data listings by changing at least one value corresponding to at least one data element in said obtained identifying data of said member.

7. The method of claim 4, wherein said comparing comprises comparing each of said identifying data listings to identifying data of each other member in said group of people.

8. The method of claim 4, wherein said group of people comprises a group of participants in a clinical trial, said medical information comprises results of said clinical trial, and said member comprises a specific participant in said clinical trial.

9. The method of claim 8, wherein said group of people additionally comprises a group of participants in at least one other clinical trial.

10. The method of claim 5, wherein said group of people comprises a group of participants in a clinical trial, said medical information comprises results of said clinical trial, said member comprises a specific participant in said clinical trial, and said reevaluating comprises recalculating said results of said clinical trial following removal of data relating to said at least one removed member.

11. The method of claim 4, wherein said medical information comprises information regarding adverse events attributed to a pharmaceutical, said member comprises a specific patient for whom an adverse event was reported, and said group of people comprises a group of patients for whom adverse events were reported.

12. The method of claim 11, wherein said member comprises a specific patient for whom an adverse event was reported with relation to said pharmaceutical.

13. The method of claim 5, wherein said medical information comprises information regarding adverse events attributed to a pharmaceutical, said member comprises a specific patient for whom an adverse event was reported, said group of people comprises a group of patients for whom adverse events were reported, and said reevaluating comprises reassessing a list of adverse events associated with said pharmaceutical following removal of data relating to said at least one removed member.

14. The method of claim 4, wherein at least one of said comparing and said removing is carried out as a background process.

15. A device for improving the accuracy of medical information, comprising:
a comparison module configured to compare identifying data of each specific member in a group of people used to determine said medical information at least to identifying data of each other member in said group; and
an analysis module functionally associated with said comparison module and configured to:
remove said specific member and at least one other member in said group from said group of people if said identifying data of said specific member matches identifying data of said at least one other member; and
if at least one member was removed from said group of people, notify a user of said removal of said at least one member.

16. The device of claim 15, wherein said analysis module is further configured to reevaluate said medical information following removal of said at least one member.

17. The device of claim 15, also comprising a data manipulation module configured to create multiple identifying data listings by changing at least one value corresponding to at least one data element in said identifying data of said specific member.

18. The device of claim 17, wherein said comparison module is configured to compare each of said identifying data listings to identifying data of each other member in said group of people.

19. The device of claim 15, wherein said group of people comprises a group of participants in a clinical trial, said medical information comprises results of said clinical trial and said specific member comprises a specific participant in said clinical trial.

20. The device of claim 16, wherein said group of people comprises a group of participants in a clinical trial, said medical information comprises results of said clinical trial, said specific member comprises a specific participant in said clinical trial, and said analysis module is configured to reevaluate said medical information by recalculating said results of said clinical trial following removal of data relating to said specific participant in said clinical trial.

21. The device of claim 15, wherein said medical information comprises information regarding adverse events caused by a pharmaceutical, said specific member comprises a specific patient for whom an adverse event was reported, and said group comprises a group of patients for whom adverse events were reported.

22. The device of claim 21, wherein said member comprises a specific patient for whom an adverse event was reported with relation to said pharmaceutical.

23. The device of claim 16, wherein said medical information comprises information regarding adverse events caused by a pharmaceutical, said specific member comprises a specific patient for whom an adverse event was reported, said group comprises a group of patients for whom adverse events were reported, and said analysis module is configured to reevaluate said medical information by reassessing a list of adverse events associated with said pharmaceutical, following removal of data relating to said at least one member.
